(19) United States
(12) Patent Application Publication
(10) Pub. No.: US 2013/0294211 A1
(43) Pub. Date: Nov. 7, 2013

(54) OPTICAL PICKUP DEVICE AND METHOD FOR MANUFACTURING THE SAME

(71) Applicant: Hitachi Media Electronics Co., Ltd., Oshu-shi (JP)

(72) Inventors: Hiroaki FURUICHI, Kawasaki-shi (JP); Akiko MIZUSHIMA, Yokohama-shi (JP); Kazuhiko ITO, Yokohama-shi (JP); Ryuichiro MIZUNO, Fujisawa-shi (JP); Tamotsu NISHIDA, Yokohama-shi (JP)

(21) Appl. No.: 13/887,392

(22) Filed: May 6, 2013

(30) Foreign Application Priority Data
May 7, 2012 (JP) 2012-105971

(51) Int. Cl. G11B 7/08

(52) U.S. Cl. CPC G11B 7/08
USPC 369/112.23; 248/205.3; 156/275.5

(57) ABSTRACT

The optical pickup device includes a light-emitting element that emits light, an objective lens that converges light emitted by the light-emitting element on an external optical recording medium, a light-receiving element that receives the light returned from the optical recording medium via the objective lens, a holder that holds the light-emitting element or the light-receiving element, and a casing to which the holder is secured with an adhesive interposed therebetween. The holder has a holder's bonding surface to be bonded to the casing, while the casing has a case's bonding surface facing the holder's bonding surface and to be bonded to the holder. The holder's or casing's bonding surface is provided with adjoining sidewalls that have wall faces forming an angle with the holder's or casing's bonding surface. The holder and casing are adhesively secured to each other with a UV-curable adhesive applied on the holder's or casing's bonding surface.

### CLAIM OF PRIORITY

The present application claims priority from Japanese patent application serial no. JP 2012-105971, filed on May 7, 2012, the content of which is hereby incorporated by reference into this application.

### BACKGROUND OF THE INVENTION

(1) Field of the Invention

This invention relates to an optical pickup device used for recording and reproducing data on optical recording media, such as CDs (compact discs), DVDs (digital versatile discs), BDs (blue-ray discs (registered mark)) and a method for manufacturing the optical pickup device, and, for instance, relates to a technique of adhesively securing components of the optical pickup device, including optical components, laser diodes (LD), and light-receiving elements.

(2) Description of the Related Art

An optical pickup device used for recording and reproducing data on optical recording media, such as CDs, DVDs, and BDs, includes an optical system that guides light emitted from a light-emitting element, such as a laser diode, via various lenses, prisms, mirrors and some other components to an objective lens that converges the light on an optical recording medium and an optical system that guides the light returned from the optical recording medium via the objective lens, other various lenses, prisms, mirrors and other components to a photoelectric conversion element that converts the light output into an electrical signal.

One of disclosures of the background technology in this field is Japanese unexamined patent publication serial no. 2005-32314. This publication discloses a feature “in a method for securing a holding member, which holds a light-emitting element or a light-receiving element, to an optical chassis with a UV (ultraviolet)-curable resin adhesive placed in a space provided for alignment between the holding member and the optical chassis”. The feature is that “the UV-curable resin adhesive is mixed with inorganic compound powder that allows UV to pass through the adhesive and therefore can ensure a necessary amount of UV light for the adhesive and can reduce flow deformation occurring during curing thereby to reduce misalignment”.

Japanese unexamined patent publication serial no. 2007-109302 also discloses the background technology. This publication discloses “an optical pickup configured to enable reduction in change of optical element properties when the optical element is bonded to a housing with an adhesive, maintenance of the adhesive strength, and avoidance of an increase in the scale of production facility”. In addition, Japanese unexamined patent publication serial no. 2010-146642 also discloses the background technology. This publication discloses “a structure in which a holder, which holds a LD or a light-receiving element, is bonded to an optical pickup casing with a UV-curable adhesive”. In the structure, protrusions are formed on a bonding surface of the holder to make areas that are irradiated with less UV light in the adhesive, and the UV-curable adhesive in other areas that are irradiated with more UV light is cured in advance. Even if the UV-curable adhesive in the high irradiance areas shrinks, the uncured UV-curable adhesive in the low irradiance areas flows to the shrunk areas, thereby reducing the shrinkage between the holder and optical casing.

### SUMMARY OF THE INVENTION

The adhesive mixed with the UV-transmitting type inorganic compound powder in the Japanese unexamined patent publication serial no. 2005-32314 can ensure the necessary amount of UV light and suppress the curing shifts in the position of the adhesive itself; however, no description is given of any special measures or actions concerning the method of UV irradiation during UV curing. Japanese unexamined patent publication serial no. 2007-109302 describes that the plurality of projections are adhesively secured to a plane to reduce changes of optical element properties caused by misalignment and to maintain the adhesion strength; however, since the projections are arranged in the same plane and the adhesive needs to be cured in the narrow spaces on the plane, UV light needs to be emitted from many directions, which requires a large space for UV irradiation in an assembly line. In addition, the Japanese unexamined patent publication serial no. 2010-146642 discloses the low UV irradiance areas formed to reduce shrinkage of the adhesive between the holder, which holds the LD or light-receiving element, and the casing; however, the amount of UV light that reaches a center part of the adhesive is resultantly small and therefore it takes longer to cure the adhesive with UV light.

The above-described Japanese unexamined patent publications put the main focus on reduction of shrinkage or misalignment of the adhesive during curing by means of the powder mixed with the adhesive and UV irradiation techniques, but not positively describe any methods to shorten the UV irradiation time. However, the UV irradiation time for UV curing tends to be longer to adhesively secure a holder, which holds an LD or a light-receiving element, to an optical pickup case with a UV-curable adhesive interposed therebetween, because the UV-curable adhesive needs to be applied thick and be applied to an larger area to achieve proper alignment and adhesive strength.

The present invention provides an optical pickup device configured to increase the amount of UV irradiation to the center of the adhesive to shorten the UV irradiation time, and a method for manufacturing the optical pickup device. In addition, the present invention provides an optical pickup device configured to achieve great adhesive strength by increasing the amount of UV radiation to the center of the adhesive and reducing the difference in UV curing degree between the surface and center part of the adhesive, and a method for manufacturing the optical pickup device.

Among a plurality of means to solve the aforementioned problem, the first representative aspect of the present invention will be directed below. In an optical pickup device including a light-emitting element that emits light, an objective lens that converges the light emitted from the light-emitting element onto an external optical recording medium, a light-receiving element that receives the light having returned from the optical recording medium via the objective lens, a holder that holds the light-emitting element or the light-receiving element, and a casing to which the holder is secured with an ultraviolet curable adhesive interposed therebetween, the holder or casing has a plurality of grooves formed so as to sandwich the optical axis of the light-emitting element or light-receiving element, and the adhesive is placed on a bottom of the grooves so as to leave spaces between the adhesive and sidewalls of the grooves.

In the optical pickup device of the first aspect, the sidewalls according to the second aspect have wall faces that are convex faces projecting in the middle in the direction in which the grooves are formed.

In the optical pickup device of the first or second aspect, the wall faces of the sidewalls according to the third aspect are convex faces each having an apex in a position corresponding to a center part of the ultraviolet curable adhesive applied in the grooves. The center part is located in the direction in which the grooves are formed.

In the optical pickup device of the first or second aspect, the wall faces of the sidewalls according to the fourth aspect are convex faces projecting in the middle in the direction in which the grooves are formed and each of which has a flat portion at the center in the direction in which the grooves are formed.

In the optical pickup device of the fourth aspect, the flat portions of the wall faces of the sidewalls according to the fifth aspect are less than half of the applied ultraviolet curable adhesive in length in the direction in which the grooves are formed.

In the optical pickup device of the fifth aspect, the flat portions of the wall faces of the sidewalls according to the sixth aspect are in contact with the applied ultraviolet curable adhesive.

In the optical pickup device of the first to sixth aspects, the wall faces of the sidewalls according to the seventh aspect are opposed to each other with respect to the applied ultraviolet curable adhesive sandwiched therebetween.

In the optical pickup device of any of the first to seventh aspects, a space is provided between the applied ultraviolet curable adhesive and the sidewalls according to the eighth aspect.

In the ninth aspect, an optical element securing unit includes a holder that holds a light-emitting element emitting light or a light-receiving element receiving the light and a stationary section to which the holder is secured with an adhesive interposed therebetween. The holder or stationary section has a plurality of grooves formed so as to sandwich the optical axis of the light-emitting element or the light-receiving element. The adhesive is placed on a bottom of the grooves so as to leave spaces between the adhesive and sidewalls of the grooves.

In the tenth aspect, a method for manufacturing an optical pickup device, which includes a light-emitting element that emits light, an objective lens that converges light emitted by the light-emitting element on an external optical recording medium, a light-receiving element that receives the light returned from the optical recording medium via the objective lens, a holder that holds the light-emitting element or the light-receiving element, and a casing to which the holder is secured with an adhesive interposed therebetween, includes a step of applying an ultraviolet curable adhesive at a bottom of grooves formed in the holder or the casing so as to leave spaces between the adhesive and sidewalls of the grooves and a step of curing the ultraviolet curable adhesive by applying ultraviolet rays in the direction in which the grooves are formed to secure the holder to the casing.

In the curing step of the method for manufacturing the optical pickup device of the tenth aspect, according to the eleventh aspect, the sidewalls have wall faces that are convex faces projecting in the middle in the direction in which the grooves are formed and, in the curing step, the ultraviolet rays are reflected by the wall faces to irradiate the ultraviolet curable adhesive.

According to the present invention in which the sidewalls are configured to have wall faces that form an angle with a bonding face, when a holder holding an LD or a light-receiving element is adhesively secured to a housing of an optical pickup with an UV-curable adhesive, for example, the side walls reflect UV light and therefore increases the amount of UV light entering from the sides of the UV-curable adhesive, thereby shortening the UV irradiation time. In addition, an increase in the amount of UV light that reaches the center part of the adhesive from the sides thereof decreases the difference in curing degree between the surface and center part of the adhesive, thereby achieving high adhesive strength.

### BRIEF DESCRIPTION OF THE DRAWINGS

These and other features, objects and advantages of the present invention will become more apparent from the following description when taken in conjunction with the accompanying drawings wherein:

FIG. 1 is an exploded perspective view of an optical pickup device according to an embodiment of the present invention;

FIG. 2 is a perspective view showing an assembly status of an LD module according to the embodiment of the invention;

FIG. 3 illustrates an assembly procedure to bond the LD module to an optical pickup case according to the embodiment of the invention;

FIGS. 4A to 4C illustrate the LD module bonded to an optical pickup case in an adhesion state according to the embodiment of the invention;

FIG. 5 illustrates bonding surfaces of the LD module and the optical pickup case irradiated with UV light according to the embodiment of the invention;

FIG. 6 illustrates the relationship between adhesive depth and UV transmittance of a UV-curable adhesive;

FIG. 7 illustrates bonding surfaces of an LD module and an optical pickup case irradiated with UV light according to a related example;

FIG. 8 is a partially enlarged view of FIG. 5;

FIG. 9 illustrates another configuration of bonding surfaces of the LD module and the optical pickup case irradiated with UV light according to the embodiment of the invention;

FIGS. 10A to 10B illustrate the LD module bonded to the optical pickup case in another adhesion state according to the embodiment of the invention;

FIG. 11 illustrates bonding surfaces of the LD module and the optical pickup case irradiated with UV light according to another embodiment of the invention; and

FIG. 12 is a partially enlarged view of FIG. 11.

### DETAILED DESCRIPTION OF THE EMBODIMENT

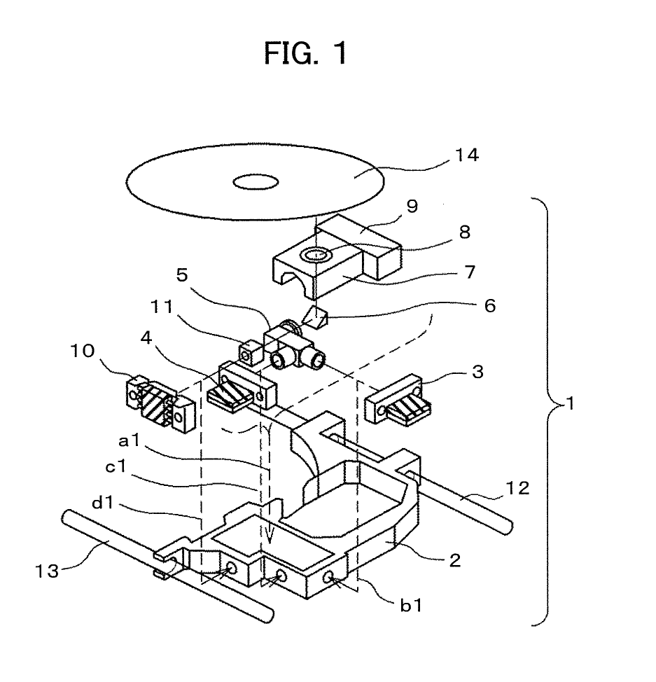

With reference to FIG. 1, the configuration of an optical pickup device according to an embodiment of the present invention will be described. FIG. 1 is an exploded perspective view of the optical pickup device of the embodiment to illustrate the structure of how optical components, which will be described later, are adhesively secured to an optical pickup case 2. In this embodiment, the structure for adhering a component to a casing of the optical pickup device is established by providing side walls on a bonding surface of the component opposed to the casing, the sidewalls being roughly perpendicular to the bonding surface and roughly parallel with the thickness direction of the casing, and by applying an UV-curable adhesive by injection on the bonding surface adjoining the sidewalls and irradiating the adhesive with UV light to adhesively secure the casing and the component.

As shown in FIG. 1, the optical pickup device 1 includes an LD module (light-emitting element module) 3, which includes a light-emitting element for emitting light, such as a laser diode (LD), an LD module 4, a prism 5, a reflecting mirror 6, an actuator 7, an objective lens 8, a lens 11, a light-receiving element module 10, which includes a photoelectric conversion element, and an optical pickup case 2, which accommodates these optical pickup components.

In the optical pickup device 1 of the above configuration, light beams emitted from the LD modules 3 and 4 are synthesized or reflected by the prism 5 and then are guided via the reflecting mirror 6 to the objective lens 8 disposed on the actuator 7. The spot of the light emitted from the light-emitting element is converged by the objective lens 8 upon an optical disc 14, which is an optical recording medium. The light (returning light) that has been reflected by the optical disc 14 passes through the objective lens 8, reflecting mirror 6, prism 5, and lens 11 and is received by the light-receiving element in the light-receiving element module 10 that forms an image.

The actuator 7 is an optical component module that controls the objective lens 8, which converges light on a recording surface of the optical disc 14, to move it in a focusing direction (direction to move toward or away from the optical disc surface), a tracking direction (radial direction of the optical disc) and a radial tilt direction (direction of tilt in the radial direction of the optical disc) with high positional accuracy (sub-micron order) to deal with the surface deflection and decentering of the spinning optical disc 14, thereby accurately reproducing information on the optical disc 14.

The actuator 7 that holds the objective lens 8 is movably supported by a stationary part 9 with a wire (not shown) having appropriate damping characteristics. The stationary part 9 is also secured to the optical pickup case 2. The wire is coupled to a printed board (not shown) disposed on the back surface of the stationary part 9 and is provided with electric current from the printed board to displace the actuator 7.

In order to achieve the above optical system, the internal components, including the actuator 7, reflecting mirror 6, prism 5, and lens 11, are mounted in the optical pickup case 2 in an assembly directional, and after that, the LD module 3, LD module 4, and light-receiving element module 10 are positionally adjusted and adhesively secured to the optical pickup case 2 in assembly directions b1, c1, and d1, respectively. The optical pickup device 1 itself is configured to move in a radial direction of the spinning optical disc 14 by actions of a main shaft 12 and a subsidiary shaft 13 to make it possible to read and write optical signals.

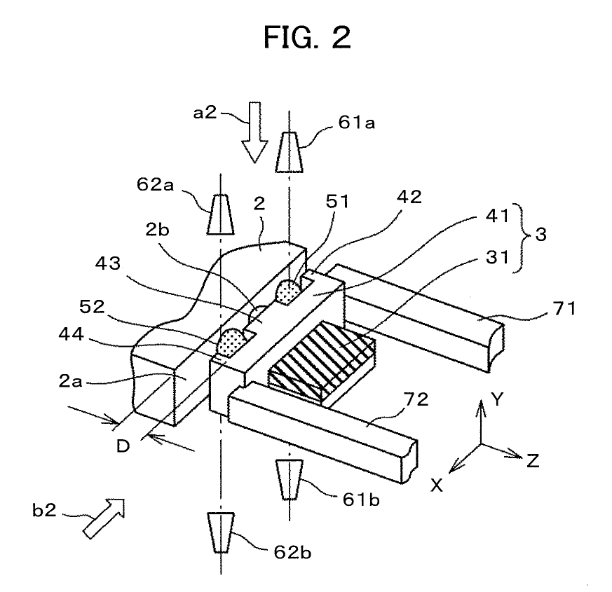

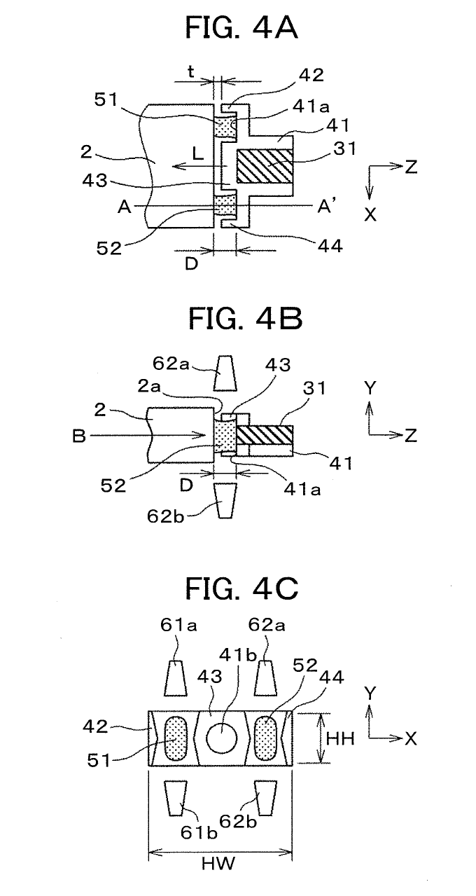

Referring to FIG. 2 and FIGS. 4A to 4C, the structure of relevant components of the embodiment will be described with the LD module 3 as an example. FIG. 2 is a perspective view showing an assembly status of the LD module 3 according to the embodiment of the invention. FIGS. 4A to 4C illustrate the LD module 3 bonded to the optical pickup case 2 in an adhesion state according to the embodiment of the invention. FIG. 4A is a plan view depicting the adhesion state of the LD module 3 and the optical pickup case 2 as viewed in a viewing direction a2 indicated in an upper part of FIG. 2 or an upper part along the Y axis. FIG. 4B is a cross sectional view taken along A-A′ of FIG. 4A as viewed in an X-axis viewing direction b2 in FIG. 2. FIG. 4C is a view as viewed in a direction B in FIG. 4B. Note that the LD module 4 and light-receiving element module 10 are bonded in the same manner as the LD module 3, and therefore their explanations will be omitted.

In FIG. 2, a holder 41 with a laser diode LD 31 fixed thereon is firmly held by positioning chucks 71, 72 so as to face the optical pickup case 2. UV-curable adhesives 51, 52 are applied between the optical pickup case 2 and the holder 41. An upper UV light source 61a and a lower UV light source 61b are disposed above and below the UV-curable adhesive 51, respectively, while an upper UV light source 62a and a lower UV light source 62b are disposed above and below the UV-curable adhesive 52, respectively, in the Y-axis direction. These UV light sources are configured as follows: for example, UV light from a UV lamp light source, such as a mercury lamp, is guided by a light guide composed of a plurality of optical fibers in a bundle and is emitted from ends of the UV light sources. Even if the UV light sources are configured to use a UV-LED as the light source and lenses or the like to collect light, the UV light sources can function as well. Note that the upward/downward directions in FIG. 2 do not always denote a vertical direction. This is also applied to the other drawings.

The structure of the holder 41 to which the LD 31 is secured will be described. The holder 41 of this embodiment is made of a metal, or, for example, is a zinc die cast in the shape of a roughly rectangular parallelepiped and holds the LD 31 which is a light-emitting element. The holder 41 has a laser through hole 41b in a side surface facing the optical pickup case 2 to allow laser beams emitted from the LD 31 to pass through. The side surface is in the shape of a rectangle with a thickness HH in the Y-axis direction of about 3 to 4 mm and a width HW in the X-axis direction of about 5 to 10 mm (see FIG. 4C). In addition, the holder 41 has holder's bonding surfaces 41a on the side surface facing the optical pickup case 2 to adhere to the optical pickup case 2. The holder's bonding surfaces 41a are parallel with the XY plane in FIG. 2. On a surface of the holder 41 opposite to the holder's bonding surfaces 41a, the LD 31 is secured with a thermosetting adhesive or the like. The LD 31 is coupled to a feeder cable (not shown) or the like.

In this embodiment provided are sidewalls 42, 43, 44 with wall faces adjoining the holder's bonding surfaces 41a and being roughly perpendicular to the holder's bonding surfaces 41a (see FIG. 4A). The wall faces of the sidewalls 42, 43, 44 are formed roughly parallel with the direction of UV light emitted from the UV light source 61a and the other light sources and also roughly parallel with the YZ plane in FIG. 2. In other words, the wall faces of the sidewalls 42, 43, 44 stand in a direction roughly perpendicular to the X-axis direction in FIG. 2 or the holder's bonding surfaces 41a. In addition, the wall faces of the sidewalls 42, 43, 44 are rectangles, which are longer in the Y-axis direction than the Z-axis direction (see FIG. 4B).

In this embodiment, the wall faces of the sidewalls 42, 43, 44 are formed roughly perpendicular (or may be just perpendicular) to the holder's bonding surfaces 41a; however, as will be described later, since the sidewalls 42, 43, 44 are formed to reflect the UV light emitted from the UV light sources and to irradiate the UV-curable adhesive with the reflected UV light, the wall faces of the sidewalls 42, 43, 44 can be formed at any angle, rather than roughly perpendicular, to the holder's bonding surfaces 41a as long as the sidewalls 42, 43, 44 can lead the reflected light to the UV-curable adhesive. As will be described later, UV-curable adhesives are applied between the sidewalls 42, 43, 44 to adhesively secure the holder 41 and optical pickup case 2.

Next will be a description of the structure of the case's bonding surface 2a of the optical pickup case 2 to which the holder 41 is adhesively secured. The optical pickup case 2 of this embodiment is made of an engineering plastic, such as PPS (Polyphenylenesulfide) and PBT (Polybutylene Terephthalate), in view of the moldability, mechanical strength and so on; however, metal is also applicable to the case. As with the holder's bonding surfaces 41a, the case's bonding surface 2a of this embodiment is parallel with the XY plane in FIG. 2 and faces the holder's bonding surfaces 41a to be bonded to the holder's bonding surfaces 41a. The case's bonding surface 2a is rectangular in this embodiment and has a case's optical axis hole 2b formed therein so as to face the laser through hole 41b of the holder 41. Laser beams coming out from the laser through hole 41b pass through the case's optical axis hole 2b.

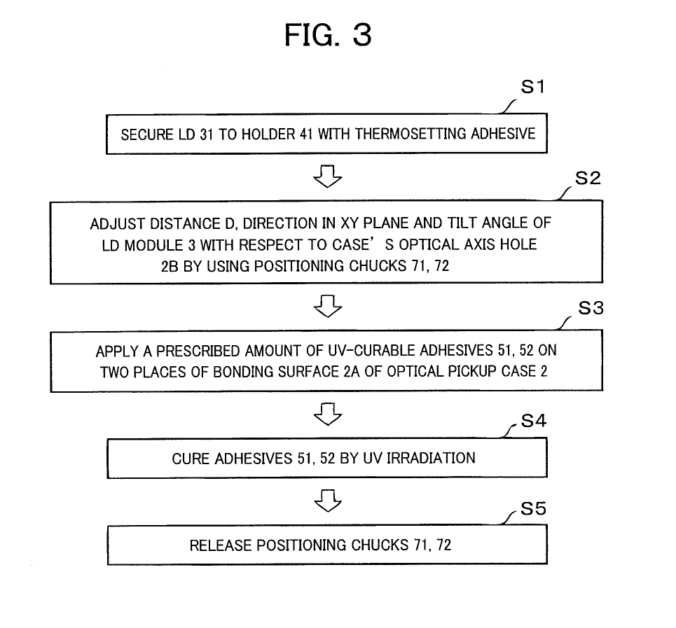

Referring to FIG. 3, an assembly procedure of the relevant components of the embodiment will be described with the LD module 3 as an example. FIG. 3 illustrates an assembly procedure to adhere the LD module 3 to the optical pickup case 2, that is, a method for manufacturing the optical pickup device 1 according to the embodiment of the invention. Since the LD module 4 and the light-receiving element module 10 are bonded in the same manner as the LD module 3, the similar assembly procedure to that for the LD module 3 can be applied to the LD module 4 and the light-receiving element module 10.

(1) In a step prior to adhesion of the holder 41 to the optical pickup case 2, the LD 31 is secured to the holder 41 with a thermosetting adhesive or the like for ease of assembly of the LD module 3 (step S1). Then, as shown in FIG. 2, the optical pickup case 2 is secured by an adjusting jig (not shown), and the LD module 3 is firmly held by the positioning chucks 71, 72. The positioning chucks 71, 72 firmly hold the LD module 3, but can adjust the position and angle of the LD module 3 three-dimensionally.

(2) While keeping the LD 31 emitting a laser beam and maintaining the laser beam emitted from the LD 31 passing through the laser through hole 41b of the holder 41 and the case's optical axis hole 2b of the optical pickup case 2, the positioning chucks 71, 72 adjust the LD module 3 to an optimal position and at an optimal angle (step S2). Specifically, the angle of the LD module 3 with respect to the optical pickup case 2 is adjusted so that the laser beam having passed through the laser through hole 41b passes through the case's optical axis hole 2b. The distance between the optical pickup case 2 and LD module 3 in the Z-axis direction, i.e., distance D between the case's bonding surface 2a and holder's bonding surfaces 41a is adjusted to a predetermined distance of, for example, 300 to 1,000 μm. The rotation angle of the LD module 3 in the XY plane, i.e., in a plane in parallel with the case's bonding surface 2a and holder's bonding surfaces 41a is adjusted to a predetermined angle.

(3) After the adjustment in (2), the distance D between the optical pickup case 2 and the LD module 3 is increased, then a prescribed amount of UV-curable adhesives 51, 52 are applied to two places of the case's bonding surface 2a of the optical pickup case 2, and the distance D is restored to its previous length at completion of the adjustment in (2) (step S3). The adhesives 51, 52 provide bridging between the case's bonding surface 2a of the optical pickup case 2 and the holder's bonding surfaces 41a of the holder 41.

(4) After that, the upper UV light source 61a and the lower UV light source 61b above and below the UV-curable adhesive 51 and the upper UV light source 62a and the lower UV light source 62b above and below the UV-curable adhesive 52 emit UV light, respectively, to harden the adhesives 51, 52 (step S4).

(5) At last, the LD module 3 is released from the positioning chucks 71, 72, and the adhesion procedure is complete (step S5).

Next, the curing behavior of adhesives during UV irradiation will be described with reference to FIGS. 4A to 4C and FIG. 7. FIG. 7 is a side view illustrating the LD module 3 bonded to the optical pickup case 2 of a related example as viewed in a X-axis viewing direction b2 of FIG. 2.

Firstly, the curing behavior of an adhesive during UV irradiation in the related example will be described with reference to FIG. 7. As shown in FIG. 7, a holder 101 of the LD module in the related example does not have sidewalls perpendicular to a bonding surface 101a of the holder 101. A UV-curable adhesive 102 is applied between a case's bonding surface 2a of an optical pickup case 2 and the bonding surface 101a of the holder 101 (distance D7). If an upper UV light source 103a and lower UV light source 103b aligned in the Y-axis direction emit UV light simultaneously, the adhesive 102 starts UV-curing from its surface that is closely exposed to the UV irradiation; however, less UV light reaches a center part of the adhesive that is thick in the Y-axis direction and therefore UV curing of the whole adhesive 102 applied in the distance D7 takes time to complete.

A curing behavior during UV irradiation of the adhesive in the embodiment of the invention, in contrast to the above conventional example, will be next described below with reference to FIGS. 4A to 4C. The holder 41 has sidewalls 42, 43, 44 with wall faces adjoining the holder's bonding surfaces 41a, roughly perpendicular to the holder's bonding surfaces 41a, and roughly parallel with the Y-axis direction, which is the thickness direction of the optical pickup case 2, and more specifically, roughly parallel with the YZ plane in FIGS. 4A to 4C. The sidewalls 42 and 44 are provided on both ends of a face, which is opposed to the optical pickup case 2, of the holder 41 in the X-axis direction, while the sidewall 43 is provided at the center of the face, which is opposed to the optical pickup case 2, of the holder 41 in the X-axis direction. The sidewall 43 has a face opposed to the case's bonding surface 2a and a laser through hole 41b formed in the center of the face as shown in FIG. 4C. FIG. 4A shows that a laser beam L emitted from the LD 31, as described above, passes through the laser through hole 41b and enters the case's optical axis hole 2b of the optical pickup case 2.

The sidewalls 42, 43, 44 have wall faces, respectively, roughly parallel with the YZ plane of FIGS. 4A to 4C, as described above. A wall face of the sidewall 42 is opposed to one of the wall faces of the sidewall 43, while a wall face of the sidewall 44 is opposed to the other wall face of the sidewall 43. Each of these wall faces is a convex face and has an apex at a position corresponding to the center of the UV-curable adhesives 51, 52 in the Y-axis direction of FIGS. 4A to 4C. The role played by the convex face will be described later.

As shown in FIGS. 4A and 4C, an adhesive 51 is applied between the sidewall 42 and sidewall 43 in the X-axis direction, and an adhesive 52 is applied between the sidewall 43 and sidewall 44. The distance D between the case's bonding surface 2a and holder's bonding surfaces 41a is, for example, 300 to 1,000 μm. The distance t between the case's bonding surface 2a and the end faces of the sidewalls 42, 43, 44 in the Z-axis direction is, for example, 100 to 200 μm. The distance t is provided to adjust the position and angle of the LD module 3 as described above. In this embodiment, the adhesives 51, 52 are applied so as not to touch the wall faces of the sidewalls 42, 43, 44 and a space is provided between the adhesives 51, 52 and the wall faces of the sidewalls 42, 43, 44. The role played by the spaces will be described later.

As shown in FIG. 4C, an upper UV light source 61a and a lower UV light source 61b are disposed above and below the adhesive 51 in the Y-axis direction (upward/downward direction), respectively, while an upper UV light source 62a and a lower UV light source 62b are disposed above and below the adhesive 52 in the Y-axis direction (upward/downward direction), respectively. These UV light sources apply UV light from above and below the adhesives 51, 52 to harden the adhesive 51, 52. During the UV irradiation, the sidewalls 42, 43, 44 reflect the UV light from the upper UV light sources 61a, 62a and lower UV light sources 61b, 62b to play a role of guiding the UV light to a center part of the adhesives 51, 52, in the Y-axis direction, bridging between the case's bonding surface 2a of the optical pickup case 2 and the holder's bonding surfaces 41a of the holder 41. Consequently, the adhesives 51, 52, which are longer in the Y-axis direction, are irradiated with direct UV light that directly reaches the adhesives from the upper UV light sources 61a, 62a and lower UV light sources 61b, 62b and with reflected UV light that has been reflected by the sidewalls 42, 43, 44.

In the embodiment as described above, the optical pickup case 2 and holder 41 are secured to each other with a plurality of ultraviolet curable adhesives that are aligned in a plane direction of the optical pickup device 1, in other words, in a plane direction of the optical disc 14 mounted on the optical pickup device 1 (X-direction in FIG. 2). The ultraviolet curable adhesives are aligned so as to sandwich the optical axis of the light-emitting element or light-receiving element. In addition, the optical pickup case 2 or holder 41 has a plurality of grooves formed in the thickness direction of the optical pickup case 2 (Y-direction in FIG. 2). These grooves are clearances provided between the sidewall 42 and sidewall 43 and between the sidewall 43 and sidewall 44. The adhesives are placed on the bottom (holder's bonding surface 41a) of the grooves formed in the thickness direction so as to leave spaces between the sidewalls (e.g., sidewall 43 and sidewall 44) of the grooves and the adhesives. In short, the holder 41 or case 2 has a plurality of grooves formed so as to sandwich the optical axis of the light-emitting element or light-receiving element, and the ultraviolet curable adhesives are placed on the bottom of the grooves so as to leave spaces between the sidewalls of the grooves and the adhesives.

In addition, the wall faces of the sidewalls (e.g., the wall face of the sidewall 44) are convex faces projecting in the middle with respect to the thickness direction, that is, the direction in which the grooves are formed, toward the adhesives, and having apexes at positions corresponding to the center part of the applied adhesives.

The sidewalls opposed to each other with the applied adhesive sandwiched therebetween form a pair, and the wall faces of the sidewalls in a pair (e.g., sidewall 43 and sidewall 44) are arranged to face each other. The part of the holder 4 or case 2 on which the adhesive is applied is larger in the thickness direction than the plane direction of the optical pickup device 1.

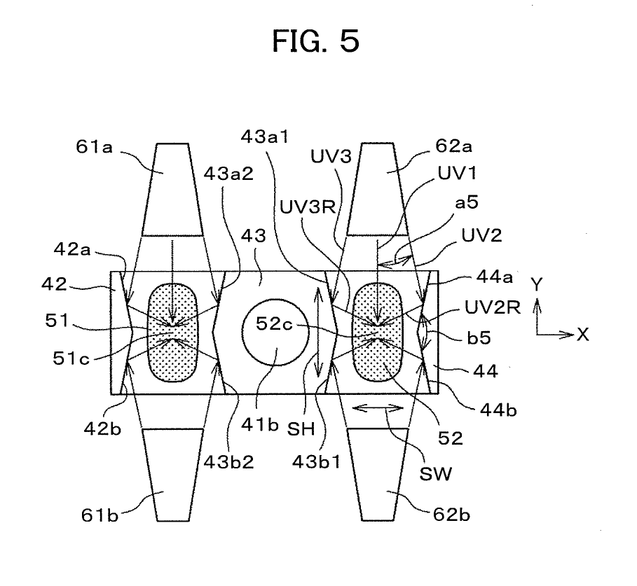

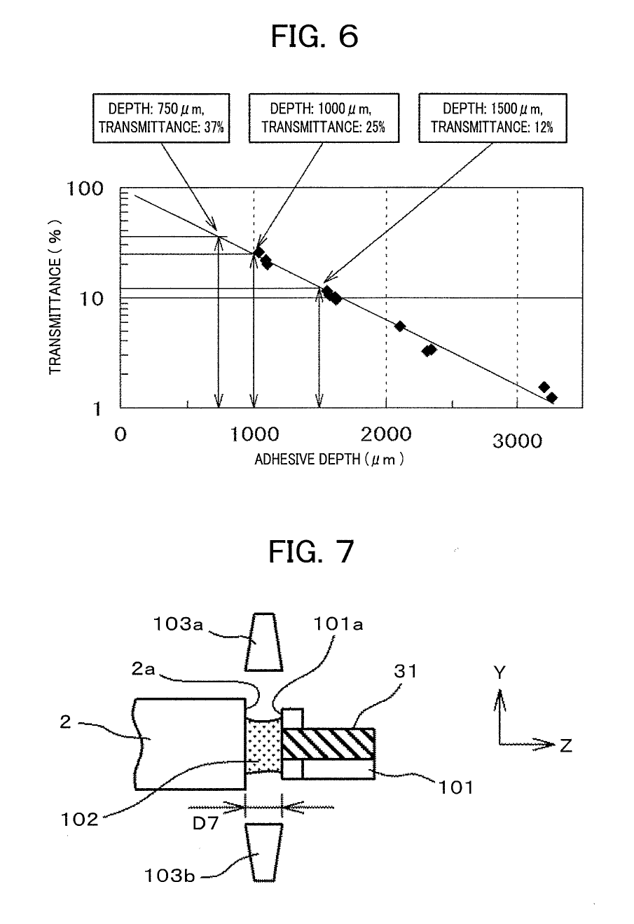

A description will be made about the path and amount of UV light reaching the adhesive in this embodiment with reference to FIGS. 5 and 6. FIG. 5 adds exemplary dimensions and a state of ray traces of the UV light of the embodiment to FIG. 4C. FIG. 6 illustrates the relationship between adhesive depth and UV transmittance of the UV-curable adhesive. Since the ray traces from the upper UV light source 61a and lower UV light source 61b to the adhesive 51 and the ray traces from the lower UV light source 62b to the adhesive 52 are the same as the ray trace from the upper UV light source 62a to the adhesive 52, only the ray trace from the upper UV light source 62a to the adhesive 52 will be described.

As shown in FIG. 5, each of the sidewalls 42, 43, 44 has a convex face with an apex in the middle along the Y-axis direction (upward/downward direction) and includes an upper sidewall having an upper reflection face and a lower sidewall having a lower reflection face. Specifically, the sidewall 42 includes an upper reflection face 42a and a lower reflection face 42b, the sidewall 44 includes an upper reflection face 44a and a lower reflection face 44b, and the sidewall 43 includes an upper reflection face 43a2 opposite to the upper reflection face 42a, a lower reflection face 43b2 opposite to the lower reflection face 42b, an upper reflection face 43a1 opposite to the upper reflection face 44a, and a lower reflection face 43b1 opposite to the lower reflection face 44b.

The upper and lower reflection faces shown in the example of FIG. 5 are all flat, but can be in other shapes, for example, a curved shape. Also in the example of FIG. 5, the upper reflection face 44a and lower reflection face 44b are axisymmetrical in shape with the upper reflection face 43a1 and lower reflection face 43b1 opposed thereto about a center line of the adhesive 52 in the Y-axis direction (upward/downward direction), while the upper reflection face 42a and lower reflection face 42b are axisymmetrical in shape with the upper reflection face 43a2 and lower reflection face 43b2 opposed thereto about a center line of the adhesive 51 in the Y-axis direction (upward/downward direction). In addition, the upper reflection face 43a1 and lower reflection face 43b1 are axisymmetrical in shape with the upper reflection face 43a2 and lower reflection face 43b2 about a center line of the laser through hole 41b in the Y-axis direction (upward/downward direction). The reflection faces of course do not need to be axisymmetrical as described above and can be shaped in other ways.

In this embodiment, the adhesive 52 applied between the case and holder has a height SH in the Y-axis direction of approximately 1,500 to 3,000 μm and a width SW in the X-axis direction of approximately 1,000 to 2,000 μm. The dimensions show that the adhesive 52 is shaped to be longer in the Y-axis direction (upward/downward direction) than in the X-axis direction (lateral direction). In addition, the adhesive 52 is placed between the case's bonding surface 2a and holder's bonding surface 41a with a space between the sidewalls 42, 43 and adhesive so as not to touch the sidewalls 42, 43.

The upper UV light source 62a for emitting UV light is generally a light guide or the like made by bundling a plurality of optical fibers, which are made of vitreous silica or the like with high UV transmittance, to have a diameter of approximately 3 to 7 min. If lenses or other optical components are not used to collect UV light, UV light emitted from the light source has a divergence angle a5 of approximately 12 degrees according to the numerical aperture (NA) of the optical fibers (e.g., approximately 0.2 for silica fibers). A comparison of the amount of UV light is made between UV1, which is a direct incident UV light beam emitted from the center of the upper UV light source 62a to a center part 52c of the adhesive 52, and UV2, which is an ambient incident UV light beam emitted with a divergence angle a5 to the center part 52c of the adhesive 52.

By the way, in an exemplary relationship between adhesive depth and UV transmittance of a UV-curable adhesive, the UV transmittance decreases sharply with the depth in the adhesive pursuant to Lambert's law as shown in FIG. 6. In FIG. 6, the horizontal axis represents adhesive depth (μm), while the vertical axis represents transmittance (%) of UV light. For example, as shown in FIG. 6, the UV transmittance at an adhesive depth of 750 μm is 37%, the UV transmittance at an adhesive depth of 1,000 μm is 25%, and the UV transmittance at an adhesive depth of 1,500 μm is 12%.

In FIG. 5, UV1, which is a direct incident UV light beam emitted from the center of the upper UV light source 62a and directly entering the center part 52c of the adhesive 52, travels one-half of the adhesive height SH to reach the center part 52c of the adhesive 52. Given that one-half of the height SH of the adhesive 52 is 1,500 μm, the UV transmittance is approximately 12%. The 12% of the UV light contributes to the curing of the center part of the adhesive 52. If there are no sidewalls 42, 43, 44, the upper UV light source 62a cures the adhesive with only UV1.

On the other hand, the ambient incident UV light beam UV2 emitted with a divergence angle a5 is reflected by the upper reflection face 44a of the sidewall 44 and the reflected UV light beam UV2R reaches the center part 52c of the adhesive 52. The upper reflection face 44a and lower reflection face 44b of the sidewall 44 form a reflection face angle b5 that is an obtuse angle, thereby facilitating the reflected UV light beam UV2R to reach the center part 52c of the adhesive 52 from the upper reflection face 44a. Since the holder 41 is made of metals, for example, is a Zn (zinc) die cast, the reflection surface 44a is relatively smooth and probably can achieve about 50% UV reflectance.

Furthermore, the adhesive 52 is applied to be longer in the Y-axis direction (upward/downward direction) than in the X-axis direction (lateral direction) and to leave a space between the sidewalls 42, 43 and the adhesive as described above. Because of this, the distance of the adhesive depth for the reflected UV light beam UV2R reflected by the upper reflection face 44a of the sidewall 44 to the center part 52c of the adhesive 52 is relatively short, thereby suppressing reduction of the UV transmittance.

The reflected UV light beam UV2R travels about one-half of the adhesive width SW until reaching the center part 52c of the adhesive 52. Given that one-half of the width of the adhesive 52 is 500 to 1,000 μm, the UV transmittance is approximately 50 to 25%. It is found from calculation of the aforementioned reflection and transmittance that 25% to 12% of the ambient incident UV light beam UV2 contributes to the curing of the center part 52c of the adhesive 52. Furthermore, a reflected UV light beam UV3R, which is derived from an ambient incident UV light beam UV3 reflected by the upper reflection face 43a1, also reaches the center part 52c of the adhesive 52 with the same UV transmittance. In total, 50% to 25% of the ambient incident UV light beam UV2 (or UV3) reaches the center part 52c of the adhesive 52.

Consequently, the amount of UV light contributing to the curing of the center part 52c of the adhesive 52 in the presence of the sidewalls 42, 43, 44 as described in this embodiment is calculated by (amount of UV light directly reaching the center part of adhesive: 12%)+(amount of UV light reflected and reaching the center part of adhesive: 50% to 25%)=62% to 37%, which is 5 to 3 times greater than 12% of UV light in the absence of the sidewalls 42, 43, 44. The increase in the amount of UV light can shorten the UV irradiation time.

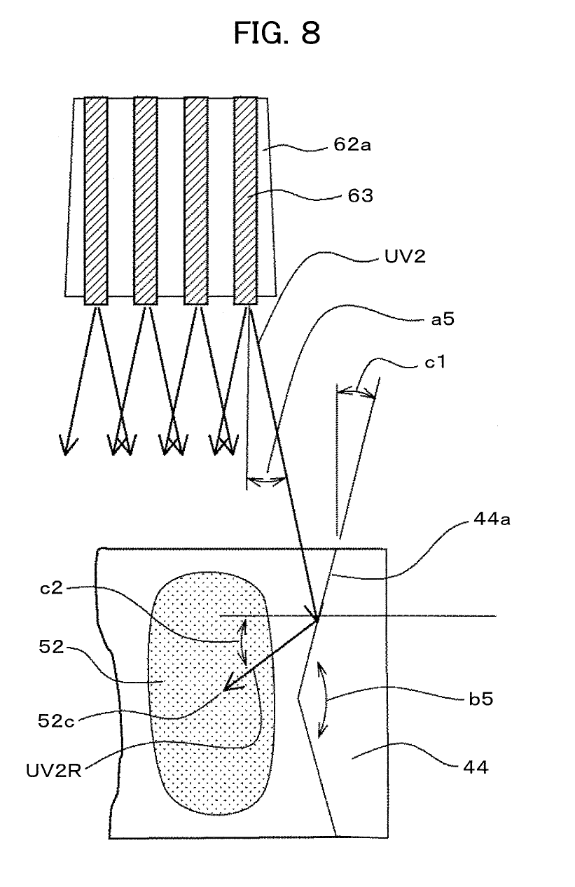

An appropriate degree of the reflection face angle b5 and an appropriate shape of the convex face of the sidewalls are considered. FIG. 8 illustrates bonding surfaces of the LD module and optical pickup case irradiated with UV light according to the embodiment of the invention and is a partially enlarged view of FIG. 5. The upper UV light source 62a is generally a light guide or the like made by bundling a plurality of optical fibers 63, which are made of vitreous silica or the like with high UV transmittance, and emits UV light with a divergence angle a5 of approximately 12 degrees according to the numerical aperture of the optical fibers (e.g., approximately 0.2 for silica fibers) if lenses or other optical components are not used to collect UV light. The ambient incident UV light beam UV2 emitted with a divergence angle a5 is reflected by the upper reflection face 44a tilted at an angle c1 with respect to a vertical direction and the reflected UV light beam UV2R reaches the center part 52c of the adhesive 52 at an incident angle c2 with respect to a horizontal direction. Given that the divergence angle a5=12° and if, for example, the reflection face angle c1=10°, it is estimated that the reflection face angle b5=160° and the incident angle to the adhesive c2=58°. Alternatively, if the reflection face angle c1=39°, the reflection face angle b5=102° and the incident angle to the adhesive c2=0°. Specifically speaking, in order for UV2, or the ambient incident UV light beam, to travel downward in the Y-axis direction to enter into the center part 52c of the adhesive, the reflection face angle c1 of the upper reflection face 44a with respect to the vertical direction is 39° or lower, and the reflection face angle b5 formed by the upper reflection face 44a and lower reflection face 44b of the sidewall 44 is an obtuse angle of 102° or higher.

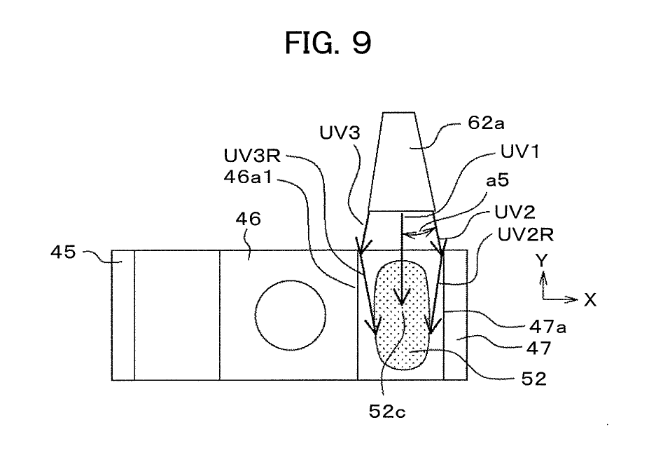

Next, consideration will be given to a case where a sidewall 47a and sidewall 46a1 are vertical, that is, the reflection face angle b5 is 180° as shown in FIG. 9. Similar to FIG. 8, UV light emitted from the upper UV light source 62a has a divergence angle a5 of approximately 12°. The ambient incident UV light beam UV2 emitted with a divergence angle a5 is reflected by a vertical sidewall 47a and the reflected UV light beam UV2R enters in the adhesive at an incident angle c2 of 78° with respect to the horizontal direction, but does not reach the center part 52c of the adhesive 52. As a result, only the direct incident UV light beam UV1 reaches the center part 52c of the adhesive 52 and the ambient incident UV light beam UV2 reflected by the sidewalls increases the light amount, but cannot be effectively used. This result confirms that a preferable angle at the center part of the sidewalls is an obtuse angle ranging from 102° or more but less than 180°.

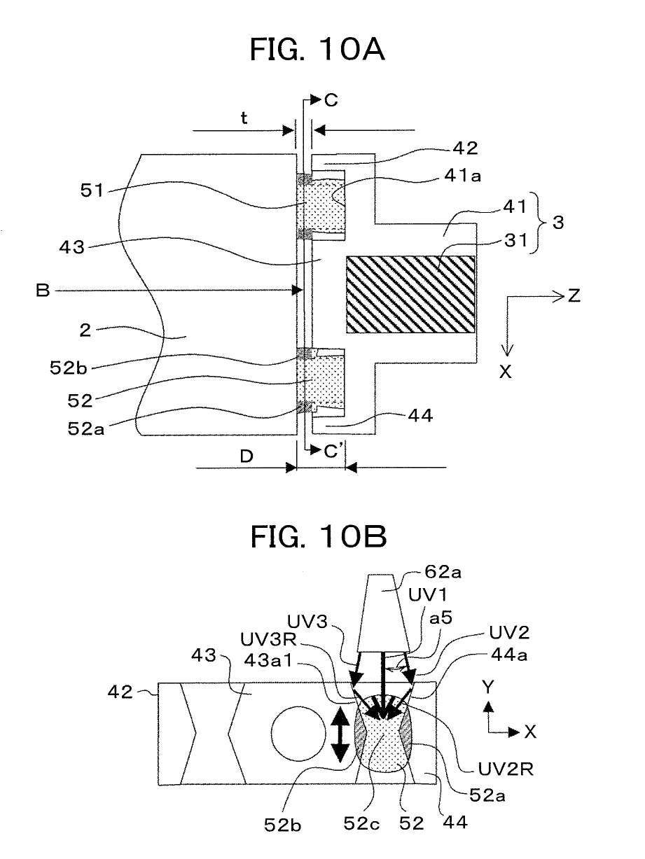

By the way, the amount of the adhesive 52 to be applied by a general pneumatic dispenser sometimes fluctuates by approximately ±50% relative to the initially set amount because of variance of viscosity of the adhesive caused by temperature and some other factors. A case where an excessive amount of the adhesive is applied and the adhesive wets and spreads between the optical pickup case and sidewalls will be described with reference to FIGS. 10A and 10B. FIG. 10A is a plan view depicting the LD module 3 bonded to the optical pickup case 2 as viewed in a viewing direction a2 indicated in an upper part of FIG. 2 or an upper part along the Y axis. FIG. 10B is a view of a cross section taken along C-C′ in FIG. 10A as viewed in the direction B. If an excessive amount of the adhesive 52 is applied, the adhesive wets and spreads over the space between the optical pickup case 2 and sidewalls 43, 44, and flows off as adhesives 52a, 52b. The distance t of the space is a necessary minimum distance to adjust the position and angle of the LD module 3, and ranges, for example, from 100 to 200 μm. However, when the distance t is approximately 100 to 200 μm, the direct incident UV light beam UV1 is attenuated as it travels up to approximately 1,500 μm in depth of the adhesive and a reduced amount of the light beam UV1 reaches the adhesive, which retards the curing of the adhesives 52a, 52b. In order to provide an adequate amount of the UV light beam UV1 to approximately 1500 μm in depth of the adhesive, the distance t needs to be approximately 500 μm; however, such a widened distance t naturally increases distance D between the optical pickup case 2 and LD module 3, i.e., the thickness of the adhesive 52, and resultantly induces greater adhesive contraction or expansion through the course of UV curing and in thermal and moisture history. The contraction or expansion easily causes misalignment and angle error of the LD module 3 and therefore deteriorates reliability. This demonstrates that there should preferably be no adhesives 52a, 52b, and even if there are, the amount of the adhesives 52a, 52b should be preferably small.

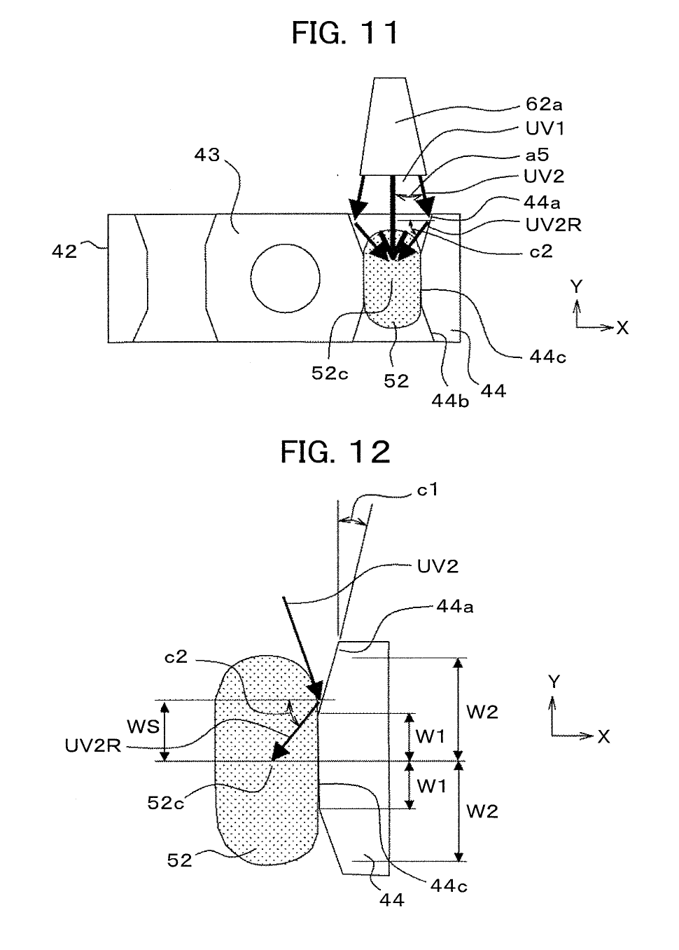

In order to solve the problem, FIG. 11 illustrates a structure in which the obtuse-angled parts of the wall faces are flattened to reduce the adhesive from flowing off. FIG. 11 is a view of a cross section of the structure according to another embodiment of the present invention taken along C-C′ of FIG. 10A, as with the case of FIG. 10B, viewed in the direction B. Since UV radiation travels in the same manner on both the right and left sides, only behavior of a right half of UV light UV1 will be described. The apex at which the upper reflection face 44a and the lower reflection face 44b of the sidewall 44 cross and the vicinity of the apex are cut off flat to form a flat portion 44c. This structure inhibits the adhesive from flowing off to the gap between the sidewall 44 and optical pickup case 2, while allowing the UV light reflected by the upper reflection face 44a and lower reflection face 44b to reach the center part of the adhesive 52, thereby achieving rapid UV curing of the whole adhesive.

With reference to FIG. 12, the height W1 of the flat portion 44c from the center of the adhesive is defined. FIG. 12 is a partially enlarged view of the adhesive 52 and the vicinity in FIG. 11. As described above, the UV light is emitted from the optical fibers with a divergence angle of approximately 12°, the ambient incident UV light beam UV2 is reflected by the upper reflection face 44a tilted at an angle c1 with respect to the vertical direction and the reflected UV light beam UV2R reaches the center part 52c of the adhesive 52 at an incident angle c2 with respect to the horizontal direction. If the divergence angle a5=12° and the reflection face angle c1=10°, the incident angle to the adhesive c2=58°. Specifically speaking, to make it possible for the UV light beam UV2R that is reflected by the wall face and enters into the adhesive at an incident angle c2 of approximately 58° or lower to reach the center part 52c of the adhesive, a preferable height WS from the center of the adhesive to the reflected point is ½ of the adhesive height W2 or more. It can be said in other words that a preferable height W1 of the flat portion is less than ½ of the height W2 of the adhesive.

As described above, in the embodiment shown in FIGS. 11 and 12, the wall face of the sidewall 44 is a convex face projecting in the middle in the thickness direction (Y-direction in FIG. 11) of the optical pickup device 1 and has a flat portion at the center part thereof in the thickness direction. In addition, the length of the flat portion 44c of the wall face of the sidewall 44 (two times longer than W1) is less than half of the length of the applied UV curable adhesive 52 (two times longer than W2) in the thickness direction of the optical pickup device 1. Furthermore, a part (i.e., the flat portion 44c) of the wall face of the sidewall 44 is in contact with the applied UV curable adhesive 52.

The above-described structure allows UV light beams emitted only in one axial direction, i.e., the Y-axis direction, to reach sides of the adhesive, thereby eliminating the necessity for installing a plurality of UV irradiation devices, such as the light guides. Thus, instead of conventionally used UV lamps, UV-LEDs (Light Emitting Diodes) capable of emitting high-intensity, high-density UV light can be used to emit light in the same axial direction to complete the curing process within a shorter time. In addition, an increase in the amount of UV light that enters the sides of the adhesive to reach the center part thereof decreases the difference in curing degree between the surface and the center part of the adhesive, thereby achieving high adhesive strength.

The aforementioned embodiments provide the following effects: (1) The sidewalls roughly perpendicular to the holder's bonding face contribute to increasing the amount of UV light reaching the center part of the adhesive, thereby shortening time required for UV irradiation and reducing the difference in curing degree between the surface and center part of the adhesive to enhance the adhesive strength. (2) The sidewalls designed to have convex wall faces can further increase the amount of UV light that reaches the center of the adhesive. (3) The convex faces of the sidewalls having apexes at positions corresponding to the center part of the applied UV-curable adhesive make it easy for UV light emitted in the upward/downward directions to reach the center part of the adhesive. (4) The plurality of sidewalls arranged so that the wall faces of the sidewalls are opposed to each other with the applied UV-curable adhesive sandwiched therebetween can further increase the amount of UV light that reaches the center part of the adhesive. (5) The space provided between the applied UV-curable adhesive and the sidewalls can suppress attenuation of the UV light reflected by the sidewalls and increase the amount of the UV light that reaches the center part of the adhesive. (6) Since UV light emitted in only one axial direction (e.g., Y-axis direction) can enter into the adhesive from the sides thereof, the number of UV irradiation devices can be reduced.

It should be understood that the invention is not limited to the foregoing embodiments and various changes and modifications may be made without departing from the spirit of the invention. Although the sidewalls are provided on the LD module side and the bonding face of the optical pickup case is shaped flat without a convex or concave face in the aforementioned embodiments, it is also possible to provide sidewalls to the optical pickup case and a flat face to the LD module side, or to provide sidewalls to both the LD module and optical pickup case. Although the UV light sources emit light in both the upward and downward directions in the aforementioned embodiments, the present invention can be configured to apply light in only one of the upward and downward directions. Alternatively, the present invention can be configured to apply light in other directions in addition to the upward and downward directions. In addition, the sidewalls on the holder's bonding surface are formed so as to be roughly parallel with the Y-axis direction, which is the thickness direction of the optical pickup case in the aforementioned embodiments; however, the sidewalls do not always need to be roughly parallel with the Y-axis direction as long as the sidewalls are roughly parallel with the direction in which the light travels from the UV light sources. Furthermore, the aforementioned embodiments describe adhesion between the LD module and the optical pickup case; however, the present invention is not limited thereto and is applicable, for example, to bond other items than the optical pickup case.

What is claimed is:

1. An optical pickup device comprising:
a light-emitting element that emits light;
an objective lens that converges light emitted by the light-emitting element on an external optical recording medium;
a light-receiving element that receives the light returned from the optical recording medium via the objective lens;
a holder that holds the light-emitting element or the light-receiving element; and
a casing to which the holder is secured with an ultraviolet curable adhesive interposed therebetween;
wherein the holder or the casing has a plurality of grooves formed so as to sandwich the optical axis of the light-emitting element or the light-receiving element, and
the adhesive is placed on a bottom of the grooves so as to leave spaces between the adhesive and sidewalls of the grooves.

2. The optical pickup device according to claim 1,
wherein the sidewalls have wall faces that are convex faces projecting in the middle in the direction in which the grooves are formed toward the adhesive.

3. The optical pickup device according to claim 1,
wherein the wall faces of the sidewalls are convex faces each having an apex in a position corresponding to a center part of the ultraviolet curable adhesive applied in the groove, the center part being located in the direction in which the grooves are formed.

4. The optical pickup device according to claim 1,
wherein the wall faces of the sidewalls are convex faces projecting in the middle in the direction in which the grooves are formed and each of which has a flat portion at the center in the direction in which the grooves are formed.

5. The optical pickup device according to claim 4, wherein
the flat portions of the wall faces of the sidewalls are less than half of the applied ultraviolet curable adhesive in length in the direction in which the grooves are formed.

6. The optical pickup device according to claim 1,
wherein a portion of the wall faces of the sidewalls is in contact with the applied ultraviolet curable adhesive.

7. The optical pickup device according to claim 1,
wherein the wall faces of the sidewalls in pairs are opposed to each other with respect to the applied ultraviolet curable adhesive sandwiched therebetween.

8. The optical pickup device according to claim 1,
wherein a part of the holder or the casing where the adhesive is placed is longer in the direction in which the grooves are formed than in the direction perpendicular to the direction in which the grooves are formed.

9. An optical element securing unit comprising:
a holder that holds a light-emitting element emitting light and a light-receiving element receiving the light; and
a stationary section to which the holder is secured with an adhesive interposed therebetween;
wherein the holder or the stationary section has a plurality of grooves formed so as to sandwich the optical axis of the light-emitting element or the light-receiving element, and
the adhesive is placed on a bottom of the grooves so as to leave spaces between the adhesive and sidewalls of the grooves.

10. A method for manufacturing an optical pickup device that includes:
a light-emitting element that emits light;
an objective lens that converges light emitted by the light-emitting element on an external optical recording medium;
a light-receiving element that receives the light returned from the optical recording medium via the objective lens;
a holder that holds the light-emitting element or the light-receiving element; and
a casing to which the holder is secured with an adhesive interposed therebetween, the method comprising the steps of:
applying an ultraviolet curable adhesive on a bottom of grooves formed in the holder or the casing so as to leave spaces between the adhesive and sidewalls of the grooves, and
curing the ultraviolet curable adhesive by applying ultraviolet rays in a direction in which the grooves are formed to secure the holder and the casing.

11. The method for manufacturing the optical pickup device according to claim 10,
wherein the sidewalls have wall faces that are convex faces projecting in the middle in the direction in which the grooves are formed, and
in the curing step, the ultraviolet rays are reflected by the wall faces of the sidewalls to irradiate the ultraviolet curable adhesive.
